(19) United States
(12) Patent Application Publication
(10) Pub. No.: US 2025/0270090 A1
(43) Pub. Date: Aug. 28, 2025

(54) LOW TEMPERATURE SYNTHESIS OF MONAZITE-TYPE MATERIALS

(71) Applicant: UNIVERSITY OF SOUTH CAROLINA, COLUMBIA, SC (US)

(72) Inventor: Hans-Conrad zur Loye, COLUMBIA, SC (US)

(21) Appl. No.: 19/063,432

(22) Filed: Feb. 26, 2025

Related U.S. Application Data
(60) Provisional application No. 63/558,219, filed on Feb. 27, 2024.

(51) Int. Cl. C01B 25/26

(52) U.S. Cl. CPC C01B 25/265

(57) ABSTRACT

The present disclosure is generally directed to methods for forming anhydrous rare earth and actinide phosphate minerals. In some embodiments of the present disclosure, the method generally comprises subjecting rare earth or actinide phosphates or salts thereof to microwave radiation.

### CROSS REFERENCE TO RELATED APPLICATION

This application claims filing benefit of U.S. Provisional Patent Application Ser. No. 63/558,219 having a filing date of Feb. 27, 2024, which is incorporated herein by reference for all purposes.

### FEDERAL RESEARCH STATEMENT

This invention was made with government support under DE-SC0016574 awarded by the U.S. Department of Energy. The government has certain rights in the invention.

### BACKGROUND

Energy demand has increased in most markets around the world for several decades. In order to meet this demand, various technologies have been developed. While fossil fuels currently supply the bulk of energy needs for most countries, other countries have developed energy markets based either partly or majorly upon nuclear energy. While nuclear energy has certain advantages over other forms of energy production, one issue with nuclear energy is the concentrated radioactive waste that it produces.

Nuclear waste provides a unique challenge in that even after it has been “spent” via a fission reaction, it remains dangerously radioactive for thousands of years. Thus, what is needed in the art are methods to safely sequester and store nuclear waste. Various methods have been attempted with different degrees of success. For instance, spent nuclear rods are sometimes encased with concrete and buried deep within the earth. However, eventually, high energy particles emitted by the nuclear waste may degrade the integrity of the encasing, leading to potential release of radioactive material.

Rare earth phosphates, such as monazite, have been proposed as a means to sequester radioactive materials. One difficulty with this approach is that synthesis of phosphate minerals like monazite often requires high temperatures and pressures, leading to difficulties with this approach.

As such, there is a need for methods for synthesizing rare earth phosphates without the use of high temperatures and/or pressures, which act as a barrier to their use in nuclear waste sequestration.

### SUMMARY

According to some embodiments of the present disclosure, a method for the low temperature synthesis of monazite-type materials is described.

In embodiments, a method for converting starting reactants which comprise a non-hydration-resistant phosphate mineral to a hydration-resistant phosphate mineral comprises the steps of microwave heating the starting reactants in the presence of water is described.

Further, in some embodiments, a method for direct synthesis of hydration-resistant phosphate minerals is described. Said method comprises the steps of combining starting reactants comprising a rare earth or actinide salt, a source of phosphate and water, and microwave heating the starting reactants.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a chart of the formation of rhabdophane and monazite.

FIG. 2 is a flowchart showing the potential methods of synthesizing hydration-resistant phosphate minerals as described herein.

FIG. 3A is a PXRD pattern of NdPO₄·nH₂O (rhabdophane) prepared via microwave synthesis in 30 minutes at 100° C. Tick lines at the bottom of the pattern represent the allowed Bragg reflections.

FIG. 3B is a PXRD pattern of the same sample after heating to 1200° C. to transform the sample to NdPO₄ (monazite). Tick lines at the bottom of the pattern represent the allowed Bragg reflections.

FIG. 4 is an overlayed graph of PXRD patterns of rhabdophane-LnPO₄ [La—Gd] prepared by microwave processing using Ln₂O₃[La, Sm—Gd], Ln(NO₃)₃ [Ce, Pr], or Ln(OH)₃ [Nd] as starting material.

FIG. 5A is PXRD pattern of monazite-NdPO₄ prepared by microwave processing at 210° C. for 1 hour. Tick lines at the bottom of the pattern represent the allowed Bragg reflections.

FIG. 5B. is an overlayed graph of PXRD patterns of monazite-LnPO₄ [La—Gd] prepared by treating rhabdophane-LnPO₄ in H₃PO₄ (1 M) at 210° C. [La—Nd], 230° C. [Sm], or 260° C. [Eu—Gd] for one hour.

FIG. 6 is an overlayed graph of PXRD patterns of monazite-NdPO₄ prepared after different heating times at 210° C. in H₃PO₄ (1 M) and the sample after heating treatment at 1200° C. for 0.5 h.

FIG. 7 is a graph showing the percentage of phases after treatment at different pHs.

FIG. 8 is a graph of overlayed PXRD patterns of monazite-LaPO₄ prepared by microwave processing using LaF₃ or LaCl₃ as starting materials.

FIG. 9 is a graph of overlayed PXRD patterns of samples after heat treatment of rhabdophane-NdPO₄ at 800° C. for 6 h, 700° C. for 12 h, and 600° C. for 12 h.

FIG. 10 is a graph of overlayed PXRD patterns of experimental (top) and calculated (bottom) phase pure monazite-NdPO₄ crystals grown in a Li₂CO₃/MoO₃ flux.

FIG. 11 is an overlayed graph of experimental (top) and calculated (bottom) PXRD patterns of Cheralite-CaTh(PO₄)₂.

FIG. 12 is an overlayed graph of experimental (top) and calculated (bottom) PXRD patterns of SrTh(PO₄)₂.

FIG. 13 is a TGA plot of rhabdophane-NdPO₄.

FIG. 14 is an EDS spectrum of CaTh(PO₄)₂.

FIG. 15 is an EDS spectrum of SrTh(PO₄)₂.

FIG. 16A is an image of NdPO₄ crystals grown in Na₂/MoO₃.

FIG. 16B is an image of NdPO₄ crystals grown in CsCl/CsF flux.

FIG. 16C is an image of CaTh(PO₄)₂ crystals grown in Li₂CO₃/MoO₃.

FIG. 16D is an image of SrTh(PO₄)₂ crystals grown in Li₂CO₃/MoO₃.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

### Definitions

As used herein, the term “monoclinic” refers to the crystallographic symmetry of the structure of a material. A crystal system is said to be monoclinic if the three lattice vectors are equal or unequal in length and the angle between the a and b axis is 90, the angle between the b and c axis is 90 and the angle between the a and c axis is greater than 90. A crystal system is said to be tetragonal if two of the three lattice vectors are equal in length and one is different and the angles between the lattice vectors are all 90. A crystal system is said to be hexagonal if the a and b lattice vectors have the same length and the c lattice vector is the same or different and the angles between the a and c and b and c vectors are 90 and the angle between the a and b vectors is 120.

As used herein, rare earth elements include, but are not limited to, scandium, yttrium, lanthanum, cerium, praseodymium, neodymium, promethium, samarium, europium, gadolinium, terbium, dysprosium, holmium, erbium, thulium, ytterbium and lutetium. As used herein, rare earth elements may be abbreviated by their respective elemental symbol or referred to collectively as “rare earths.”

As used herein, actinide elements include, but are not limited to, actinium, thorium, protactinium, uranium, neptunium, plutonium, americium and curium. As used herein, actinides may be abbreviated by their respective elemental symbol or referred to collectively as “actinides.”

As used herein, the term “radionuclide” or the plural thereof is used to refer to an unstable isotope of an element. For instance, radionuclides include, but are not limited to, nuclear fission waste products, such as actinium, thorium, protactinium, uranium, neptunium, plutonium, americium and curium. However, the potential range of radionuclides generated by nuclear fission is broader and partially depends on the specific fission reaction used.

As used herein, the term “phosphate mineral” or the plural thereof is used to refer to a rare earth or actinide phosphate salt. For instance, specific examples include, but are not limited to, monazite, xenotime, cheralite, rhabdophane, churchite and grayite.

As used herein, the term “hydration-resistant phosphate mineral” or the plural thereof is used to refer to phosphate minerals such as monazite, xenotime or cheralite.

As used herein, the term “non-hydration-resistant phosphate mineral” or the plural thereof is used to refer to phosphate minerals such as rhabdophane, churchite or grayite.

As used herein, “monazite” and “rhabdophane” may have a chemical formula comprising lanthanum, cerium, praseodymium, neodymium, samarium, europium, gadolinium or a mixture thereof.

As used herein, “xenotime” and “churchite” may have a chemical formula comprising gadolinium, terbium, dysprosium, holmium, erbium, thulium, ytterbium, lutecium, yttrium, or a mixture thereof.

As used herein, “cheralite” and “grayite” may have a chemical formula comprising an alkaline earth and an actinide.

### DESCRIPTION

In general, the present disclosure is directed to methods for producing hydration-resistant phosphate minerals. The methods disclosed herein may have decreased energy requirements. For instance, the typical method for synthesizing hydration-resistant phosphate minerals requires that starting reactants are brought to high temperatures. The necessity of high temperatures causes the typical method of synthesis to be expensive and require specialized equipment. However, presently described herein are methods for converting starting reactants into hydration-resistant phosphate minerals utilizing relatively low temperatures. The method allows for a synthetic route to hydration-resistant phosphate minerals which have a lower associated energy cost, as well as more readily available processing equipment than is necessary for the traditional synthesis. Thus, the present disclosure enables one of skill in the art to more simply synthesize hydration-resistant phosphate minerals, which may increase their use in applications which may have prior been uneconomical or unfeasible.

The present inventors have found methods for the low temperature conversion of starting reactants to hydration-resistant phosphate minerals. The starting reactants may comprise non-hydration-resistant phosphate minerals or reactants. Thus, the present disclosure describes at least two methods for the synthesis of hydration-resistant phosphate minerals depending on the starting reactant.

In the first synthetic route to hydration-resistant phosphate minerals, starting reactants may first be reacted to form non-hydration-resistant phosphate minerals which are then processed into hydration-resistant phosphate minerals. In the second synthetic route to hydration-resistant phosphate minerals, starting reactants may be reacted to directly form the hydration-resistant phosphate minerals. In either method, heating in the presence of water may be used in order to aid in the transition of a material. Such heating methods may comprise microwave heating or conventional heating methods, such as autoclaving, may be used. Further, the step of microwave heating may comprise an autoclaving step, wherein, in some embodiments, the apparatus used for microwave heating also functions as an autoclave. Described below are various reactants which may be used to form the final hydration-resistant phosphate mineral regardless of the synthetic route followed.

Phosphate minerals are commonly used in the field of optics. However, an additional usage for phosphate minerals is as a medium for sequestering radionuclides. While other materials may be used to sequester radionuclides within a matrix, they often do not maintain their integrity over time. Without wishing to be bound to any particular theory, it is believed that this is the case because high-energy particles emitted by radionuclides can damage the surrounding matrix material. However, it is believed that phosphate minerals present a unique opportunity to sequester radionuclides in a stable manner, as the matrix may undergo self-healing when annealed, which can repair damage done by the entrained radionuclides. Thus, among other things, this makes phosphate minerals a compelling candidate for use in radionuclide sequestration, as well as the broader field of nuclear waste disposal.

Phosphate minerals may comprise rare earth or actinide phosphates having varying degrees of hydration. Phosphate minerals typically have an empirical formula of AM(PO₄)ₘ·nH₂O, wherein A generally represents an optional alkaline earth, M represents a rare earth or actinide, m is 1 or 2 and n is 0 to 1. In embodiments, m is 1 and n is 0. In other embodiments, m is 1 and n is greater than 0.667. In other embodiments, m is 2 and n is 0.667. In other embodiments, m is 2 and n is 0.

Individuals in the phosphate mineral family may include hydration-resistant rare earth phosphates or actinide phosphates, such as monazite, xenotime and cheralite as described above, as well as their non-hydration-resistant forms, rhabdophane, churchite, and grayite, respectively.

For the field of radionuclide sequestration, the hydration-resistant forms of phosphate minerals are preferable, as these forms do not create reactive species such as hydrogen peroxide, H₂O₂, or hydrogen gas, H₂, through radiolysis. Without wishing to be bound to any particular theory, it is believed that the monoclinic system of monazite prevents its hydration, as opposed to the isomeric hexagonal rhabdophane. Therefore, even anhydrous rhabdophane is susceptible to hydration. Thus, in order to form a suitable host for radionuclide sequestration, the hexagonal rhabdophane needs to be converted to monoclinic monazite. Traditionally, rhabdophane has to be subjected to heat treatment at high temperatures (i.e., greater than 1000° C.) for long periods of time to successfully convert to monazite. This energy intensive process acts as a barrier for the use of monazite in radionuclide sequestration. Furthermore, this energy intensive process applies not only to the rhabophane-monazite conversion, but also the churchite-xenotime and grayite-cheralite conversions.

Reactants which may be combined to form a phosphate mineral generally include a rare earth salt and/or an actinide salt and a source of phosphate. Salts of rare earths may comprise oxides, nitrates, fluorides, chlorides or hydroxides of rare earths. In embodiments, reactants may comprise lanthanum oxide, lanthanum nitrate, lanthanum fluoride, gadolinium oxide, gadolinium nitrate, gadolinium nitrate, europium oxide, europium nitrate, europium fluoride, samarium oxide, samarium nitrate, samarium fluoride, praseodymium oxide, praseodymium nitrate, praseodymium fluoride, neodymium oxide, neodymium nitrate, neodymium fluoride, cerium oxide, cerium nitrate, cerium fluoride, or mixtures thereof.

Actinide salts include, but are not limited to, oxides, nitrates, fluoride, chlorides hydroxides, or mixtures thereof of actinide salts. Such actinides include, but are not limited to, actinium, thorium, protactinium, uranium, neptunium, plutonium, americium, curium or mixtures thereof. The actinide may be provided in the form of an oxide as stated above, or a nitrate, as in thorium nitrate. In embodiments, the actinide may comprise actinium oxide, actinium nitrate, actinium fluoride, actinium chloride, thorium oxide, thorium nitrate, thorium fluoride, thorium chloride, protactinium oxide, protactinium nitrate, protactinium fluoride, protactinium chloride, uranium oxide, uranium nitrate, uranium fluoride, uranium chloride, neptunium oxide, neptunium nitrate, neptunium fluoride, neptunium chloride, plutonium oxide, plutonium nitrate, plutonium fluoride, plutonium chloride, americium oxide, americium nitrate, americium fluoride, americium chloride, curium oxide, curium nitrate, curium fluoride, curium chloride, or mixtures thereof.

The prior mentioned list of rare earth or actinide salts may be used to form a pure phosphate mineral which comprises a single type of rare earth or actinide. However, one of skill can envisage synthesizing a phosphate mineral from a blend of salts depending on the attributes desired for the resultant phosphate mineral. For instance a resultant phosphate mineral may comprise of from 70 wt. % to 95 wt. % of a first rare earth or actinide and of from 5 wt. % to 30 wt. % of a second rare earth or actinide, based on the total weight of the rare earth or actinide present in the phosphate mineral. In some embodiments of the present disclosure, the phosphate mineral may comprise greater than two different rare earth or actinide. Such as, the phosphate mineral may comprise of from 65 wt. % to 95 wt. % of a first rare earth or actinide, of from 5 wt. % to 35 wt. % of a second rare earth or actinide, and of from 5 wt. % to 35 wt. % of a third rare earth or actinide, based on the total weight of the rare earth or actinide present in the phosphate mineral.

The reactants may further, in some embodiments, include an alkaline earth. Examples of alkaline earths include, but are not limited to, magnesium, calcium, strontium, barium or mixtures thereof. Furthermore, the alkaline earths may be provided in elemental form, or as salts such as oxides, nitrates, chlorides, fluorides, hydroxides or mixtures thereof. In embodiments, the alkaline earth may comprise calcium nitrate, strontium nitrate, calcium fluoride, strontium fluoride or mixtures thereof.

In some embodiments of the present disclosure, sources of phosphate include, but are not limited to, NH₄H₂PO₄, (NH₄)₂HPO₄ or H₃PO₄, P₂O₅ or mixtures thereof. Further, the phosphate source may provided in the form of an organic phosphate. In some embodiments of the present disclosure, the phosphate source is provided in aqueous form.

Without wishing to be bound to any particular theory, the synthesis of hydration-resistant phosphate minerals may be carried out in the presence of water. For instance, where hydrated phosphate minerals undergo a transition to a non-hydrated phosphate mineral, a source of water may comprise the water formerly present in the mineral prior to expulsion. However, in embodiments, water may be directly added to the reaction in the form of a liquid consisting essentially of water, or comprising water, such as in the case of an aqueous acid.

In the cases of monazite, xenotime and cheralite, the hydration of the phosphate mineral is zero, and the minerals themselves are resistant to hydration. Without wishing to be bound to any particular theory, it is believed that the anhydrous monoclinic, or tetragonal for the case of xenotime, system allows the phosphate minerals to be resistant to hydration.

The non-hydration-resistant forms of phosphate minerals, rhabdophane, churchite and grayite may also have the formula of AB(PO₄)ₘ·nH₂O, wherein A, B and m are as discussed above, and n is 0 to 1. For instance, the semi-hydrate of rhabdophane, LnPO₄·0.5H₂O is a monoclinic system which may be dehydrated to LnPO₄, which is a hexagonal system which is susceptible to rehydration.

In some embodiments, the starting reactants described above may be used to first synthesize non-hydration-resistant phosphate minerals such as, as a non-limiting example, rhabdophane. The method of forming non-hydration-resistant phosphate minerals generally comprises heating a rare earth salt in the presence of a source of phosphate. The heating step may comprise heating the rare earth and/or actinide salt to a temperature of from 50° C. to 200° C., such as of from 100° C. to 180° C., such as less than 210° C. Furthermore, the heating step may last such that the rare earth salt is heated to a temperature as disclosed above for a period of time. Said period of time may be of from 20 minutes to 5 hours, such as of from 1 hour to 4 hours. This heating step can transform the starting reactants into hydrated rhabdophane.

The method as described above is generally applicable to various types of non-hydration-resistant phosphate minerals, such as churchite and grayite depending on the specific starting reactants used. Further, the salt may instead be substituted as described above. Non-hydration resistant phosphate minerals have the general formula shown above, and include, but are not limited to, species such as calcium thorium phosphate hemihydrate, lanthanum phosphate hemihydrate and neodymium phosphate hemihydrate.

Regardless of how the non-hydration-resistant phosphate mineral is obtained, the same may be converted into a hydration-resistant phosphate mineral. In order for the conversion of a non-hydration-resistant phosphate mineral to a hydration-resistant phosphate mineral to occur, the non-hydration-resistant phosphate mineral undergoes microwave heating in the presence of water. After the heating step, a portion of the non-hydration-resistant phosphate mineral will be converted to hydration-resistant phosphate mineral. The microwave heating may heat the non-hydration-resistant phosphate mineral to elevated temperatures, such as greater or equal to 200° C., such as greater than or equal to 230° C., such as greater than or equal to 260° C. Stated differently, the second step of microwave heating may be carried out a temperature less than or equal to 300° C., such as less than or equal to 260° C., such as less than or equal to 250° C. In some embodiments, conversion of non-hydration-resistant phosphate mineral to hydration-resistant phosphate mineral may be carried out under microwave heating at a temperature of from 210° C. to 300° C., such as of from 230° C. to 260° C. Furthermore, the heating step may last such that the non-hydration-resistant phosphate mineral is heated to a temperature as disclosed above for a period of time. Said period of time may be of from 1 hour to 40 hours, such as of from 10 hours to 26 hours. In some embodiments of the present disclosure, the period of time may be of from 15 hours to 24 hours. This heating step can transform a non-hydration-resistant phosphate mineral into a non-hydration-resistant phosphate mineral.

As an example of the conversion from a non-hydration-resistant phosphate mineral to a hydration-resistant phosphate mineral, rhabdophane may be converted to monazite using the above method. In embodiments, churchite may be converted to xenotime using the above method. In embodiments, grayite may be converted to cheralite using the above method.

In other embodiments of the present disclosure, the method comprises direct synthesis of hydration-resistant phosphate minerals from the individual reactants described above. The starting reactants may generally be similar to those used in the prior described process for the manufacture of rhabdophane—that is, starting reactants may comprise a rare earth salt and/or actinide salt, an optional alkaline earth, combined with a phosphate source. In some embodiments of this method, the method comprises subjecting the starting reactants to microwave heating at a temperature greater than or equal to 200° C., such as greater than or equal to 230° C., such as greater than or equal to 260° C. Stated differently, the second step of microwave heating may be carried out a temperature less than or equal to 300° C., such as less than or equal to 260° C., such as less than or equal to 250° C. In some embodiments, the second step of microwave heating may be carried out under microwave heating at a temperature of from 210° C. to 300° C., such as of from 230° C. to 260° C. Furthermore, the heating step may last such that the starting reactants are heated to a temperature as disclosed above for a period of time. Said period of time may be of from 1 hour to 20 hours, such as of from 5 hours to 15 hours. In some embodiments of the present disclosure, the period of time may be of from 1 hour to 4 hours. This heating step can transform the starting reactants into monoclinic monazite.

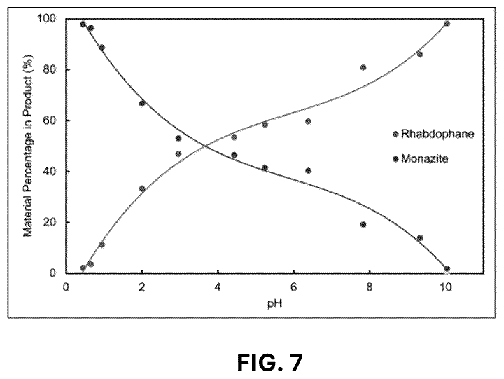

The present method makes use of other processing parameters aside from heat and time alone. For instance, the present inventors have found that the acidity of the starting reactants and/or the reaction environment may play a role in the amount of reactant transformed from the starting reactant to product. As is shown in FIG. 7, increasing pH led to a lower conversion of rhabdophane to monazite, with a near complete cessation of monazite formation at pH 10. However, increased acidity, that is lowered pH, permitted total or near total conversion of rhabdophane to monazite, such as at pH 0.5. Accordingly, in some embodiments, the method comprises introducing an aqueous acid to the starting reactants. For instance, with respect to the conversion of rhabdophane to monazite, an acid, either anhydrous or in aqueous form, such as phosphoric acid, hydrochloric acid, or any suitable acid may be introduced into the reaction so as to acidify the reaction environment. Additionally, the present inventors have found that the use of phosphoric acid fulfills the necessity to include a phosphate source when synthesizing monazite from individual constituents and the necessity to acidify said synthesis environment.

In some embodiments of the present disclosure, the starting reactants are acidified to have a pH of less than or equal to 7, such as less than or equal to 5, such as less than or equal to 4, such as less than or equal to 3.

Regardless of the method used for the synthesis of hydration-resistant phosphate minerals, the hydration-resistant phosphate minerals may be used as nuclear waste forms for the sequestration of radionuclides. For instance, radionuclides may be present in the starting reactants. The radionuclides may be present in the starting reactants at a wt. % of the total starting reactants in an amount less than or equal to 60 wt. %, such as less than or equal to 45 wt. %, such as less than or equal to 30 wt. %, such as less than or equal to 15 wt. %. Stated differently, the radionuclides may be present in the starting reactants at a wt. % greater than or equal to 15 wt. %, such as greater than or equal to 30 wt. %, such as greater than or equal to 45 wt. %, such as greater than or equal to 60 wt. %. In embodiments, the radionuclide may be present in the starting reactants at a wt. % of from 15 to 60 wt. %, such as of from 20 to 40 wt. %.

Crystals of phosphate minerals may be produced as well. For instance, methods for forming hydration-resistant phosphate mineral crystals generally include heating starting reactants in the presence of a flux. As such, in some embodiments of the present disclosure, the starting reactants for crystallization may comprise rare earth or actinide salt, an optional alkaline earth, a phosphate source and a flux. The rare earth or actinide salts, optional alkaline earth and phosphate source may be as described above. The flux may include, but is not limited to, a carbonate source and molybdenum oxide or a chloride source and a fluoride source. In some embodiments, the flux may comprise sodium or lithium carbonate and molybdenum oxide. In some embodiments, the flux may comprise cesium chloride and cesium fluoride. The flux may be present in a weight ratio of flux to rare earth or actinide salt and phosphate source greater than 2.5 to 1, such as greater than 3 to 1, such as greater than 4 to 1. In embodiments, the weight of the flux to rare earth or actinide salt and phosphate source may be equal to or between 2.5 to 1 and 4 to 1.

Further, the hydration resistant phosphate minerals may be made, in some embodiments, a batch process or a continuous process. Such a continuous process may allow for minimal storage time of radionuclides, thus requiring less infrastructure at the site of radionuclide sequestration.

### DETAILED DESCRIPTION OF THE FIGURES

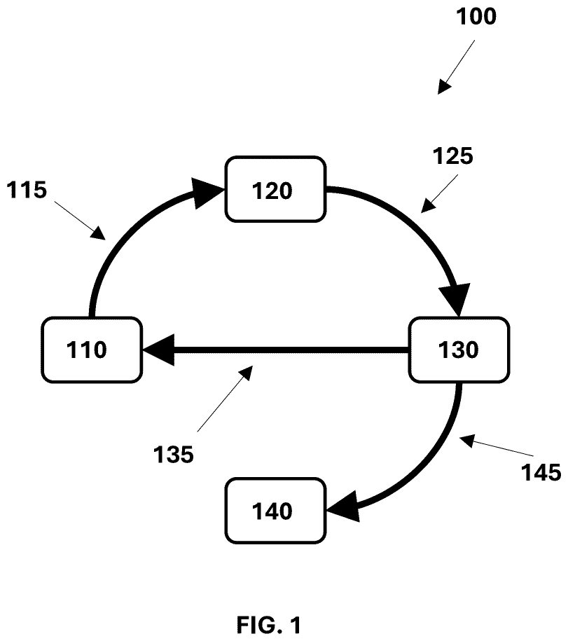

FIG. 1 is a chart 100 showing the relationship between non-hydration resistant phosphate minerals and hydration-resistant phosphate minerals. Said phosphate mineral may comprise hydrated rhabdophane 110, having a chemical formula of LnPO₄·0.667H₂O. Hydrated rhabdophane at 110 may undergo heating at 115 to around 80° C. to form rhabdophane hemihydrate 120, having chemical formula of LnPO₄·0.5H₂O. Rhabdophane hemihydrate 120 may undergo further heating at 125 at a temperature greater than 220° C. to form hexagonal rhabdophane at 130 by the expulsion of water. Said hexagonal rhabdophane 130 may undergo hydration at temperatures less than about 120° C. to reform hydrated rhabdophane 110 or undergo further heating 145 at 500° C. to 1400° C. to form monazite 140. Monazite 140 does not rehydrate to hydrated rhabdophane 110.

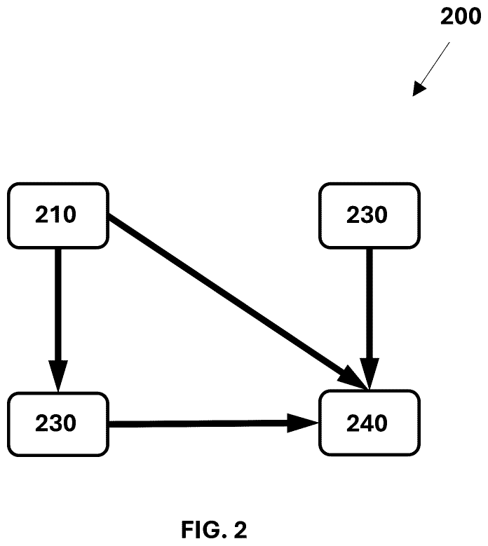

FIG. 2 is a flowchart 200 showing the potential methods of synthesizing hydration-resistant phosphate minerals. For instance, starting reactants 210 may comprise rare earth or actinide oxides, an optional alkaline earth and a phosphate source. Said starting reactants may be reacted to form a non-hydration-resistant phosphate mineral 230. Thereafter, said non-hydration resistant phosphate mineral 230 may be reacted to form a hydration-resistant phosphate mineral 240. Alternatively, starting reactants 210 may be directly reacted to hydration-resistant phosphate mineral. Additionally, non-hydration-resistant phosphate minerals 230 regardless of method of synthesis may be reacted to form hydration-resistant phosphate minerals 240.

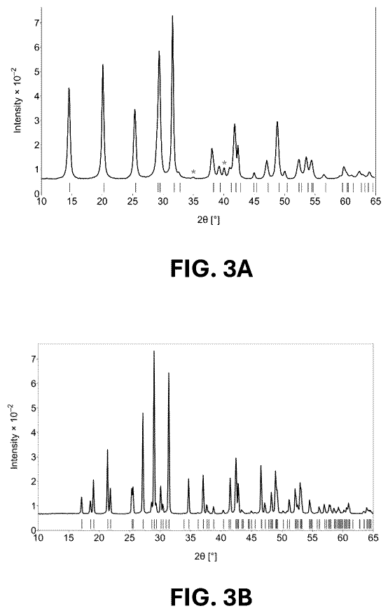

FIG. 3A is a graph of PXRD patterns performed on a sample of rhabdophane that was created via microwave synthesis. The markings at the bottom of the graph symbolize expected peak locations. As shown, there is a high correspondence between the experiment PXRD pattern found and the expected peak locations. The asterisks at 35 and 40 degrees signify peaks created by the titanium sample holder.

FIG. 3B is a graph of PXRD performed on a sample of monazite that was created from heat treating rhabdophane to 1200° C. Similarly, the sample of monazite has peaks which are in line with literature values.

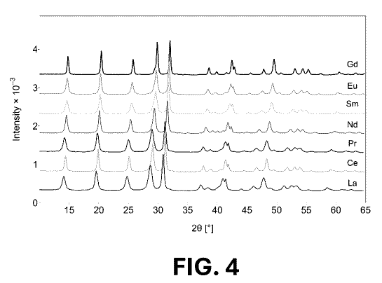

FIG. 4 is an overlayed graph of PXRD patterns performed on various hydrated phosphate minerals created by microwave synthesis. These hydrated monazite materials, i.e., rhabdophane, have consistent signatures across all lanthanides (La—Gd) tested.

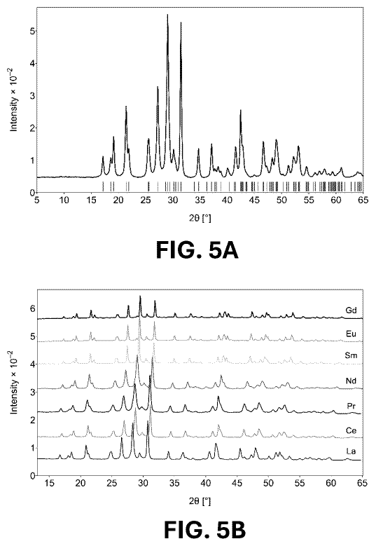

FIG. 5A is a graph of a PXRD pattern of NdPO₄. Similarly to FIG. 3A, the markings at the bottom symbolize the expected peak locations.

FIG. 5B is an overlayed graph of PXRD patterns for monazite samples containing La—Gd.

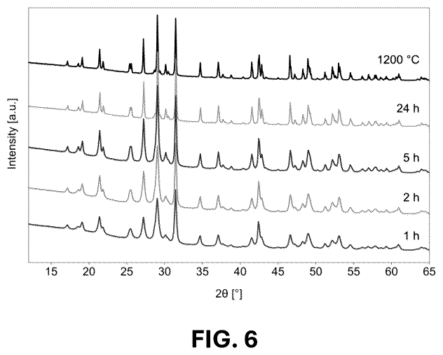

FIG. 6 is an overlayed graph of PXRD patterns for NdPO₄ for various heat treatment periods at 210° C., as well as a PXRD pattern for the sample after heat treating at 1200° C. for half an hour.

FIG. 7 is a graph showing the dependence of the rhabdophane-monazite transition on pH of the environment. Particularly, the present inventors found that at low pHs, conversion of rhabdophane to monazite was near total, whereas at high pHs, the same conversion only reached about ˜30% yield.

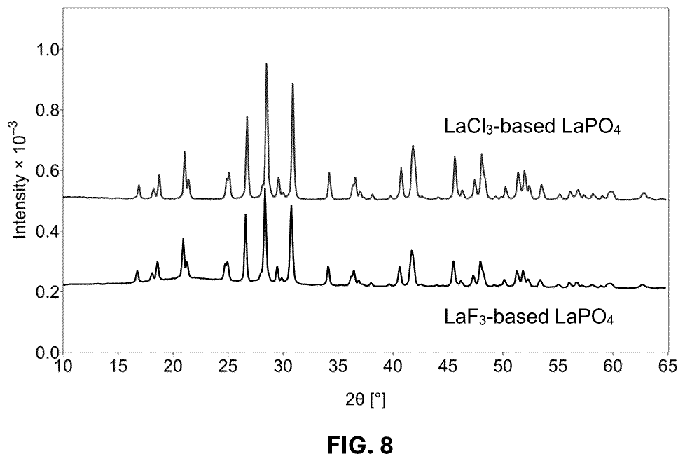

FIG. 8 is an overlayed graph of PXRD patterns of LaPO₄ created by microwave synthesis with LaCl₃ or LaF₃ as starting reactants.

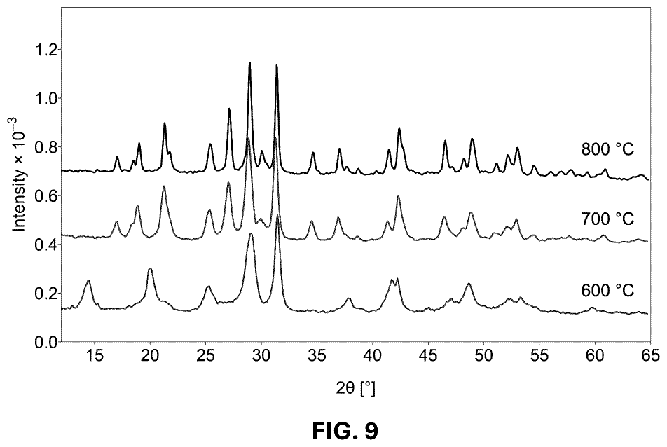

FIG. 9 is an overlayed graph of PXRD patterns of NdPO₄ after heat treatment at 600° C. for 6 hours, 700° C. for 12 hours, and 800° C. for 12 hours.

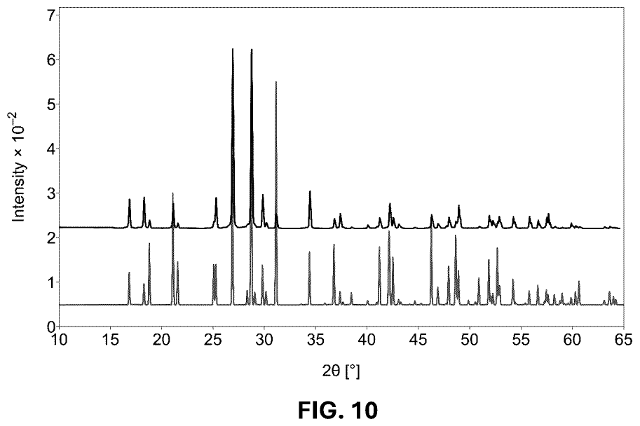

FIG. 10 is a PXRD pattern of phase pure monazite-NdPO₄ crystals grown in a Li₂CO₃/MoO₃ flux. The top line represents the experimental pattern, and the bottom line represents the calculated pattern.

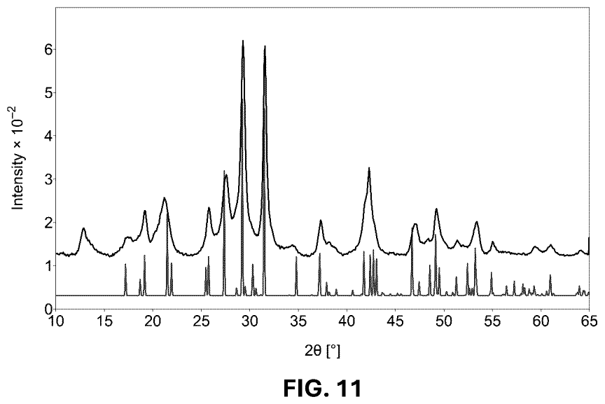

FIG. 11 is an image of overlayed PXRD patterns of Cheralite-CaTh(PO₄)₂ formed with microwave synthesis. Similarly, as above, the top line represents the experimental pattern, and the bottom line represents the calculated pattern.

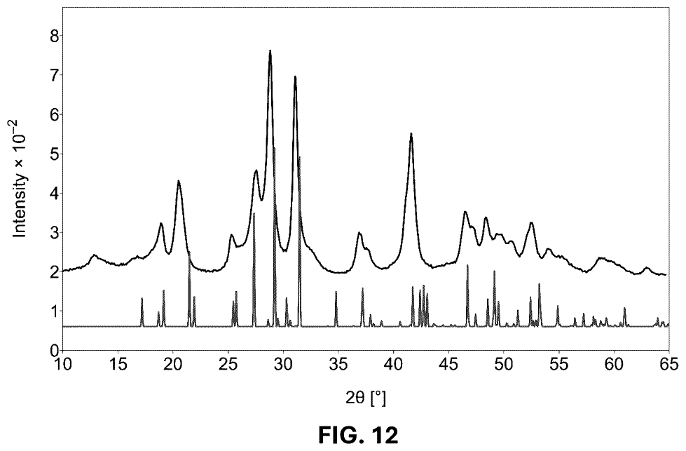

FIG. 12 is an image of overlayed PXRD patterns of SrTh(PO₄)₂ formed with microwave synthesis. The top line represents the experimental pattern, and the bottom line represents the calculated pattern.

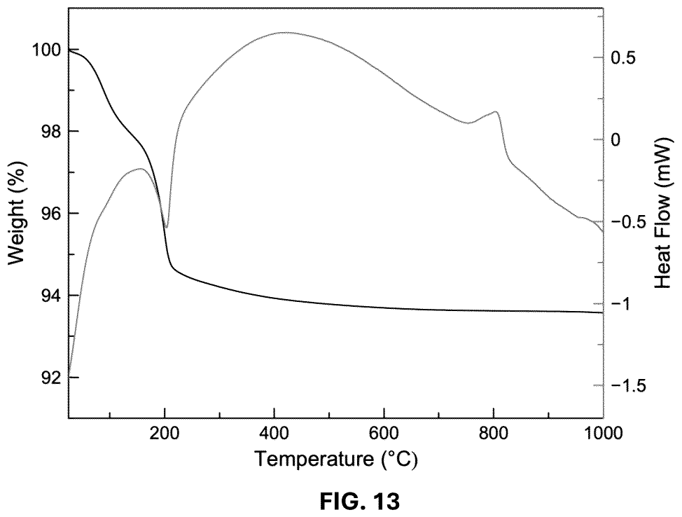

FIG. 13 is a spectrum of thermogravimetric analysis of NdPO₄. As can be seen, Nd₄PO₄ undergoes significant mass loss around 210° C., marking the conversion from the non-hydration resistant form to the hydration resistant form.

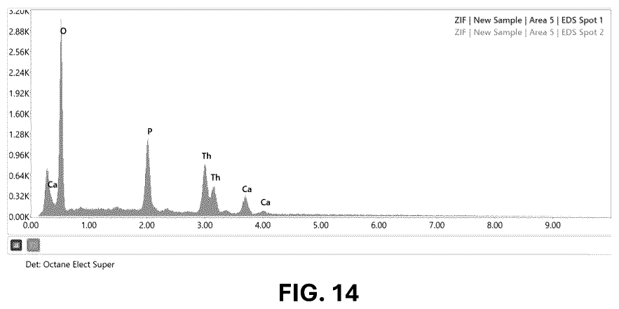

FIG. 14 is a spectrum of energy dispersive spectroscopy of CaTh(PO₄)₂.

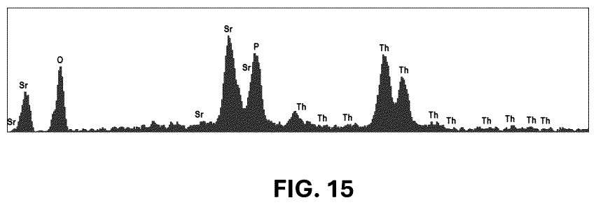

FIG. 15 is a spectrum of energy dispersive spectroscopy of SrTh(PO₄)₂.

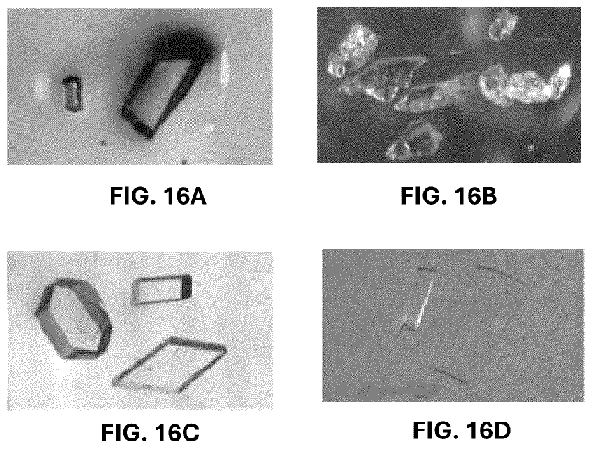

Crystals of said hydration-resistant phosphate minerals may be seen in FIGS. 16A-16D.

FIG. 16A is an image of NdPO₄ crystals grown in Na₂CO₃/MoO₃ as flux.

FIG. 16B is an image of NdPO₄ crystals grown in CsCl/CsF as flux.

FIG. 16C is an image of CaTh(PO₄)₂ grown in Li₂CO₃/MoO₃.

FIG. 16D is an image of SrTh(PO₄)₂ grown in Li₂CO₃/MoO₃.

The present invention may be better understood with reference to the examples set forth below.

### Examples

### Microwave Synthesis of Rhabdophane and Monazite

Rhabdophane-LnPO₄ (La—Gd) and monazite-LnPO₄ (La—Eu) were obtained as bulk products by performing hydrothermal reactions in the microwave-assisted heating system. Ln₂O₃/Ln(NO₃)₃/Ln(OH) s were combined in a 35 mL Pyrex tube, to which diluted H₃PO₄ (1M, 8 mL) was added. The tube was placed into the microwave system and heated under stirring to the selected temperatures. Rhabdophane-LnPO₄ (La—Eu) was obtained after heating at 100° C. for 30 minutes. Phase pure GdPO₄ was obtained after heating at 180° C. for 30 minutes. Monazite-LnPO₄ (Ln=La—Gd) is obtained by heating either the starting reactants or pre-synthesized rhabdophane-LnPO₄ (La—Nd/Sm/Eu—Gd) at 210° C./230° C./260° C. for an hour, respectively. Monazite-LnPO₄ also can be prepared by using starting reactants with either LnCl₃ or LnF₃ reacted with H₃PO₄ (1M, 8 mL) at 230° C. for an hour as shown in FIG. 7. All products were obtained by filtration and washed with water and acetone.

Cheralites, CaThPO₄ and SrThPO₄, were obtained by using Th(NO₃)₄ (0.2 mmol), Ca(NO₃)₂/Sr(NO₃)₂ (0.2 mmol) and (NH₄)₂HPO₄ (0.4 mmol) as starting reactants, 4 mL water as the solvent, reacted at 220° C. for one hour by using microwave heating. Their PXRD patterns are shown in FIGS. 10 and 11.

### pH Studies

To investigate the unexpected low temperature structural transformation further, and to determine, among other considerations, if phosphoric acid is necessary to transform rhabdophane to monazite, several experiments were performed. First, microwave heating of rhabdophane in water at 210-260° C. was carried out, which however does not result in the full conversion of rhabdophane to monazite. To establish if acidic conditions were needed for the transformation, 1 M HCl was added and the mixture heated to 210-260° C., which resulted in the complete transformation to monazite. Finally, to establish the impact of the pH value on the structure transformation a series of reactions were performed using identical temperature and heating times, however, using different pH conditions. As seen in FIG. 6, the structure transformation goes to completion most quickly at low pH but does not reach complete conversion at neutral pH and seemingly does not convert at all under basic conditions.

### Crystallization

Single crystal of monazite-NdPO₄ can also be obtained in a one-step crystal growth reaction by using (a) Li₂CO₃/MoO₃ or (b) CsCl/CsF as the flux. (a) Nd(OH)₃ (0.2 mmol, 33.6 mg) and NH₄H₂PO₄ (0.2 mmol, 23.0 mg) were reacted in a Li₂CO₃ (0.4 mmol, 29.6 mg) and MoO₃ (1.2 mmol, 172.7 mg) flux. The mixture was soaked at 1000° C. for 24 hours, and then cooled at 3° C./h to 750° C., and subsequently cooled to room temperature by turning off the furnace. Phase-pure single crystals of NdPO₄ were isolated after removing any residual flux by sonicating in distilled water (Figure S5). (b) CsCl/CsF

The single crystals of cheralite-CaTh(PO₄)₂ and monazite type SrTh(PO₄)₂ were obtained by a modified one-step flux reaction. Th(NO₃)₄·4H₂O, Ca(NO₃)₂·4H₂O or Sr(NO₃)₂ and (NH₄)₂HPO₄ (1.0 mmol, 132.0 mg) were mixed in 1:1:2 molar ratio, and combined with the flux consisting of Li₂CO₃ and MoO₃ in a 1:3 molar ratio. The mixture was soaked at 1000° C. for 24 hours, and then cooled at 3° C./h to 750° C., and subsequently cooled to room temperature by turning off the furnace. The crystals were isolated from the residual flux by sonicating in distilled water followed by vacuum filtration.

### Structure Determination

X-ray intensity data were collected at room temperature using a Bruker D8 QUEST diffractometer equipped with a PHOTON-II area detector and an Incoatec microfocus source (Mo Kα radiation, λ=0.71073 Å). The crystals were mounted on a microloop using immersion oil. The raw area detector data frames were reduced and corrected for absorption effects using the SAINT+ and SADABS programs. Final unit cell parameters were determined by least-squares refinement. Initial structural models were obtained with SHELXT. Subsequent difference Fourier calculations and full-matrix least-squares refinement against F² were performed with SHELXL-2018 using Olex2. The crystallographic data and results of the diffraction experiments are summarized in Table 1 below.

TABLE 1
Structural data of NdPO₄, CaTh(PO₄)₂ and SrTh(PO₄)₂

| Chemical | | | |
|---|---|---|---|
| formula | NdPO₄ | CaTh(PO₄)₂ | SrTh(PO₄)₂ |
| Formula weight | 239.21 | 462.06 | 254.80 |
| Crystal system | Monoclinic | Monoclinic | Monoclinic |
| Space group, Z | P2₁/n, 4 | P2₁/n, 2 | P2₁/n, 4 |
| a, Å | 6.40980(10) | 6.4117(1) | 6.5185(2) |
| b, Å | 6.95800(10) | 6.9153(1) | 7.0336(2) |
| c, A | 6.74370(10) | 6.7051(1) | 6.8070(2) |
| β, deg. | 103.6780(10) | 103.687(1) | 103.5314(9) |
| V, Å³ | 292.235(8) | 288.854(8) | 303.428(16) |
| ρ_{calcd}, g/cm³ | 5.437 | 5.313 | 5.578 |
| Radiation (λ, Å) | 0.71073 | | |
| μ, mm⁻¹ | 18.122 | 27.259 | 33.8 |
| T, K | 300.20 | 298.28 | 303(2) |
| Crystal dim., | 0.08 × 0.05 × 0.04 | 0.05 × 0.03 × 0.01 | 0.18 × 0.10 × 0.05 |
| mm³ | | | |
| 2θ range, deg. | 3.945-36.324 | 3.955-36.398 | 3.897-30.029 |
| Reflections | 20069 | 31634 | 21820 |
| collected | | | |
| Data/restraints/ | 1419/0/56 | 1414/0/56 | 888/0/57 |
| parameters | | | |
| Rᵢₙₜ | 0.0260 | 0.0277 | 0.0694 |
| Goodness of fit | 1.223 | 1.303 | 1.269 |
| R₁(I > 2σ(I)) | 0.0109 | 0.0208 | 0.0298 |
| wR₂ (all data) | 0.0219 | 0.0543 | 0.0737 |
| Largest diff. | 0.809/−0.735 | 1.325/−1.315 | 1.502/−1.549 |
| peak/hole, e · Å⁻³ | | | |

### Powder X-Ray Diffraction

PXRD data for all phases were collected on a Rigaku Ultima IV powder X-ray diffractometer with CuKα radiation (40 kV, 44 mA, λ=1.5418 Å) between 5.0 and 65.0° (2θ).

### Thermal Properties

TGA measurements were performed on rhabdophane-NdPO₄ using a TA Instruments SDT Q600. The sample was heated at 10° C./min to 1200° C. and then cooled at 10° C./min to 100° C. The results can be seen in FIG. 13

### Energy Dispersive Spectroscopy (EDS)

Crystals were mounted on an SEM stub with carbon tape. EDS data of CaTh(PO₄)₂ were collected using a Zeiss FESEM instrument equipped with a Thermo EDS attachment. The SEM was operated in low-vacuum mode with a 15 kV accelerating voltage and a 30 s accumulating time. EDS data of SrTh(PO₄)₂ were collected using a Tescan Vega 3 SEM instrument equipped with a Thermo EDS attachment. The SEM was operated in low-vacuum mode with a 20 kV accelerating voltage and a 30 s accumulating time.

While certain embodiments of the disclosed subject matter have been described using specific terms, such description is for illustrative purposes only, and it is to be understood that changes and variations may be made without departing from the spirit or scope of the subject matter.

What is claimed is:

1. A method for converting starting reactants comprising a non-hydration-resistant phosphate mineral to a hydration-resistant phosphate mineral, the method comprising:
microwave heating the starting reactants in the presence of water.

2. The method of claim 1, wherein the microwave heating lasts for 1 to 40 hours.

3. The method of claim 1, wherein the microwave heating is performed at a temperature of from 210° C. to 300° C.

4. The method of claim 1, wherein the starting reactants further comprise an acid.

5. The method of claim 1, wherein the starting reactants have a pH of less than 5.

6. The method of claim 1, wherein the formula of the non-hydration-resistant phosphate mineral is LnPO₄·nH₂O, wherein Ln is selected from the group consisting of La, Ce, Pr, Nd, Pm, Sm, Eu, Gd and Y and n is from 0 to 1.

7. The method of claim 1, wherein the formula of the non-hydration-resistant phosphate mineral is AB(PO₄)₂·nH₂O, wherein A represents an alkaline earth, B represents an actinide, and n is from 0 to 1.

8. The method of claim 1, wherein the formula of the non-hydration-resistant phosphate mineral is M(PO₄)₂·nH₂O, wherein M is selected from the group consisting of Gd, Tb, Dy, Ho, Er, Tm, Yb, Lu and n is from 0 to 1.

9. The method of claim 1, wherein the starting reactants further comprise a radionuclide.

10. A method for direct synthesis of hydration-resistant phosphate minerals comprising:
combining starting reactants comprising a rare earth or actinide salt, a source of phosphate and water; and
microwave heating the starting reactants.

11. The method of claim 10, wherein the starting reactants are microwave heated for a period of time of from 1 hour to 4 hours.

12. The method of claim 10, wherein the step of microwaving the starting reactants is performed at a temperature of from 210° C. to 300° C.

13. The method of claim 10, wherein the starting reactants have a pH less than or equal to 4.

14. The method of claim 10, wherein the starting reactants further comprise a radionuclide.

15. The method of claim 10, wherein the starting reactants further comprise flux.

16. The method of claim 10, wherein the source of phosphate is phosphoric acid.

17. The method of claim 10, wherein the starting reactants further comprise NH₄H₂PO₄ and an acid.

18. The method of claim 10, wherein the starting reactants further comprise an alkaline earth salt.
